(19) United States
(12) Patent Application Publication
(10) Pub. No.: US 2017/0166276 A1
(43) Pub. Date: Jun. 15, 2017

(54) Hard Seat Device for Bicycle

(71) Applicant: Huei-Wern Tsuei, Taipei City (TW)

(72) Inventor: Huei-Wern Tsuei, Taipei City (TW)

(21) Appl. No.: 15/235,702

(22) Filed: Aug. 12, 2016

(30) Foreign Application Priority Data
Dec. 14, 2015 (TW) 104220037

(51) Int. Cl. B62J 1/18; B62J 1/08

(52) U.S. Cl. CPC B62J 1/18; B62J 1/08

(57) ABSTRACT

A hard seat device is adapted to be mounted on a seatpost of a bicycle for supporting a hard protective cycling pad thereon, and includes a hard seat member and a linking unit. The hard seat member has a main body that is adapted for contacting the hard protective cycling pad, and that is elongated without any part expanding laterally for supporting buttocks of a rider. The linking unit is mounted to the hard seat member and is adapted to be coupled to the seatpost.

### CROSS-REFERENCE TO RELATED APPLICATION

This application claims priority of Taiwanese Patent Application No. 104220037, filed on Dec. 14, 2015.

### FIELD

The disclosure relates to a seat, and more particularly to a bicycle seat.

### BACKGROUND

Bicycle seats have the primary function of allowing a rider to be seated thereon, and are therefore generally designed to cooperate in shape with the buttocks of the human physique. In order to enhance the comfort of a seated rider, another layer of padding may be fitted in or on the pants of the rider to lessen friction between the buttocks and the seat. While most conventional pads for bicycle seats are made of soft material, recently there have been pads made of hard material with the aim of better supporting the rider. The latter type of pads possess higher structural strength and provides more support for the buttocks of the rider, preventing the buttocks from undergoing uncomfortable deformation when being seated on the pad for longer periods of time.

Most bicycle seats are designed with a centrosymmetric structure, and have two protruding structures expanding in opposite lateral directions from the center for the buttocks to rest on. Referring to FIG. 1, a conventional bicycle seat includes a front end portion 11 and two supporting portions 12. The supporting portions 12 are designed to complement the shape of buttocks, and may be covered with a soft or hard pad for enhanced comfort. However, while this design or configuration of the bicycle seat 1 ensures a large enough contact area for the buttocks of the rider to rest on, the bicycle seat 1 will inevitably have greater size and weight, and the supporting portions 12 that protrude on the two sides of the bicycle seat 1 inevitably increase drag.

### SUMMARY

Therefore, an object of the disclosure is to provide a hard seat device for a bicycle that can alleviate at least one of the drawbacks of the prior art.

A hard seat device is adapted to be mounted on a seatpost of a bicycle for supporting a hard protective cycling pad thereon, and includes a hard seat member and a linking unit. The hard seat member includes a main body that is adapted for contacting the hard protective cycling pad, and that is elongated without any part expanding laterally for supporting buttocks of a rider. The linking unit is mounted to the hard seat member and is adapted to be coupled to the seatpost.

### BRIEF DESCRIPTION OF THE DRAWINGS

Other features and advantages of the disclosure will become apparent in the following detailed description of the embodiments with reference to the accompanying drawings, of which:

FIG. 1 is a perspective view illustrating a conventional bicycle seat;

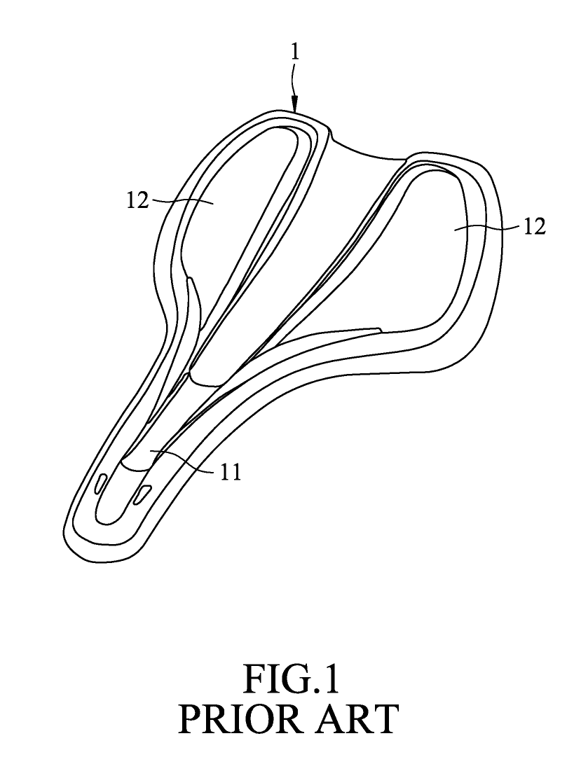

FIG. 2 is an exploded side view illustrating a hard protective pad and a first embodiment of a hard seat device according to the disclosure;

FIG. 3 is a front view illustrating the hard protective cycling pad being mounted on the first embodiment;

FIG. 4 is a side view illustrating a second embodiment of the hard seat device according to the disclosure;

FIG. 5 is a side view illustrating a third embodiment of the hard seat device according to the disclosure;

FIG. 6 is a front view of the third embodiment;

FIG. 7 is a front view illustrating a fourth embodiment of the hard seat device according to the disclosure;

FIG. 8 is a side view illustrating a fifth embodiment of the hard seat device according to the disclosure;

FIG. 9 is a front view of the fifth embodiment;

FIG. 10 is a side view illustrating a sixth embodiment of the hard seat device according to the disclosure;

FIG. 11 is a side view illustrating a seventh embodiment of the hard seat device according to the disclosure;

FIG. 12 is a side view illustrating an eight embodiment of the hard seat device according to the disclosure; and

FIG. 13 is a side view illustrating a ninth embodiment of the hard seat device according to the disclosure.

### DETAILED DESCRIPTION

Before the disclosure is described in greater detail, it should be noted that where considered appropriate, reference numerals or terminal portions of reference numerals have been repeated among the figures to indicate corresponding or analogous elements, which may optionally have similar characteristics.

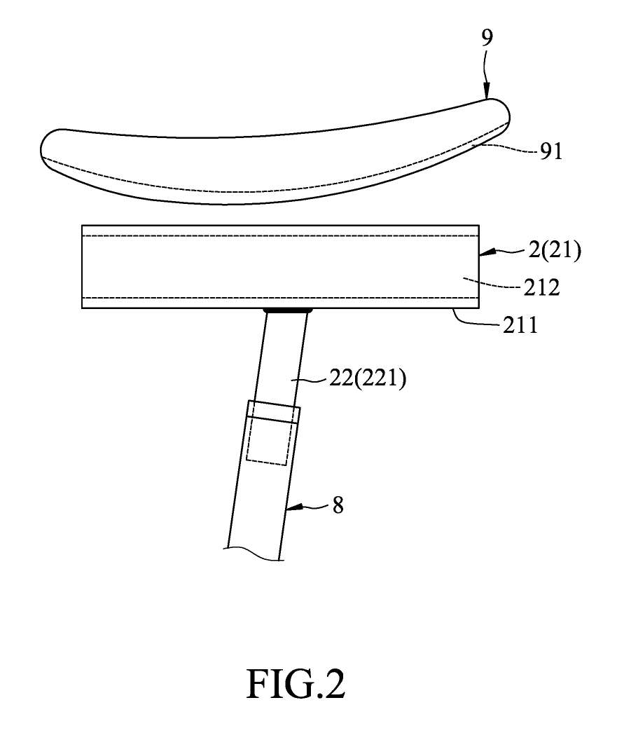

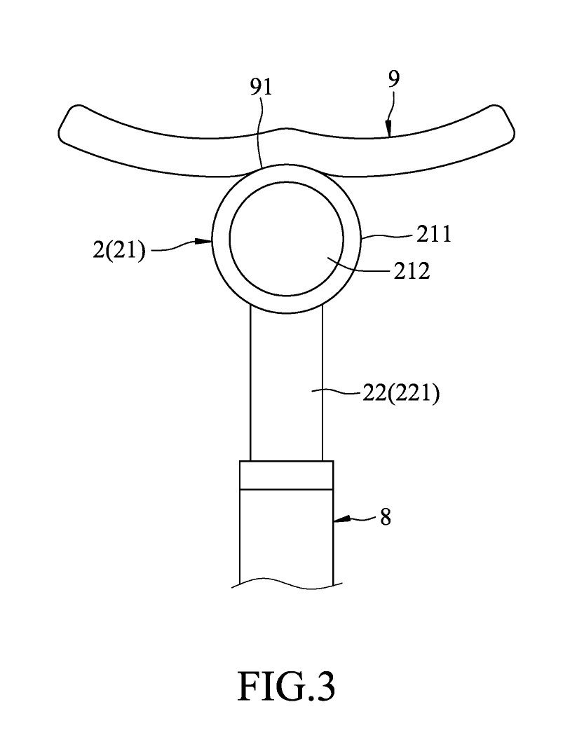

Referring to FIGS. 2 and 3, a first embodiment of a hard seat device 2 for a bicycle is suitable for being mounted on a seatpost 8 for supporting a hard protective cycling pad 9. The hard protective cycling pad 9 is made of plastic material, and includes a top side that cooperates in shape with buttocks of a rider, and a bottom side that is indented inward to form a groove 91. The hard protective cycling pad 9 may be fitted on either the inside or outside of the rider's pants to be against the buttocks, according to practical requirements.

The hard seat device 2 includes a hard seat member 21 and a linking unit 22. The hard seat member 21 includes a tubular main body 211 that extends in the front-rear direction and that defines an elongated hole 212 extending therethrough in the front-rear direction. The main body 211 is adapted for contacting the hard protective cycling pad 9, and has a shape that substantially complements that of the groove 91 of the hard protective cycling pad 9, and that is elongated without any part expanding laterally for supporting the buttocks of the rider. It should be noted that a width of an ischium of a male rider is different from that of a female rider, with the latter usually possessing a wider ischium.

The primary function of the main body 211 is to allow the hard protective cycling pad 9 to rest directly thereon, so that in practice or other embodiments, the shape of the main body 211 need only be able to complement that of the groove 91. Hence, the main body 211 may be cylindrical, spindle-shaped, and so forth. The width of the main body 211 may range at maximum from 3 to 10 centimeters, with the range of 4 to 9 centimeters being preferable, and the range of 5 to 8 centimeters being optimal. The material of the main body 211 may be plastic, metal, or alloys. In this embodiment, the main body 211 is cylindrical, with a uniform external diameter of 7 cm, and made of plastic material.

The elongated hole 212 extends through the main body 211 along a front-rear direction, and is formed by hollowing out the main body 211 to allow the passage of air therethrough so that drag can be reduced when cycling forward or rearward. The shape of the elongated hole 212 may also be any shape that can complement that of the groove 91 of the hard protective cycling pad 9. In this embodiment, the elongated hole 212 is cylindrical in accordance with the shape of the main body 211.

The linking unit 22 includes a linking member 221 that is mounted to a bottom of the hard seat member 21, that is substantially cylindrical, and that is adapted to be inserted into the seatpost 8.

The rider can first fit the hard protective cycling pad 9 on the inner or outer side of his/her pants against the buttocks, then simply seat him/herself on the hard seat member 21. Since the hard seat member 21 does not need any structures expanding left and right to accommodate the buttocks, weight and drag can be effectively reduced, with the latter further reduced by allowing air passage through the elongated hole 212 in the main body 211.

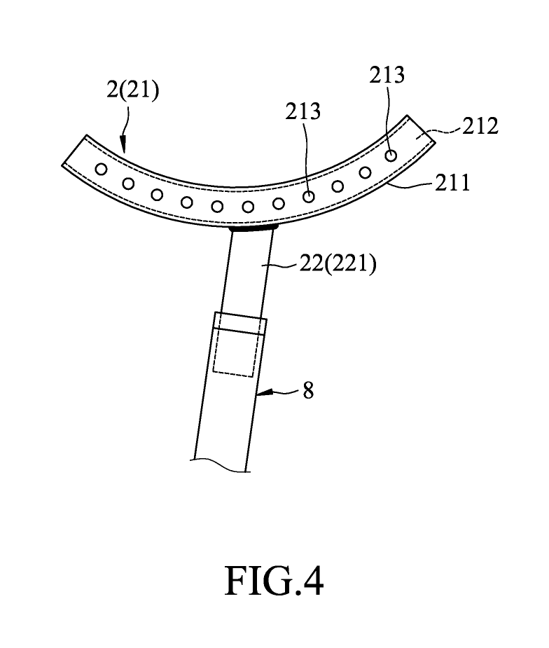

Referring to FIG. 4, a second embodiment of the hard seat device 2 for a bicycle is essentially similar to the first embodiment, except that the main body 211 of the hard seat member 21 of the second embodiment further has a plurality of apertures 213, and front and rear ends opposite to each other and being curved upwardly.

In this embodiment, the entire main body 211 is shaped in a curve, as can be seen from a side view thereof. The shape of the elongated hole 212 is also curved in accordance with that of the main body 211, but substantially extends in the front-rear direction as with the elongated hole 212 of the first embodiment.

By virtue of the curved shape of the main body 211 of the second embodiment, it will be harder for the rider to slide off the hard seat member 21, and easier for the rider to take advantage of the curvature to find a most suitable contact angle for sitting.

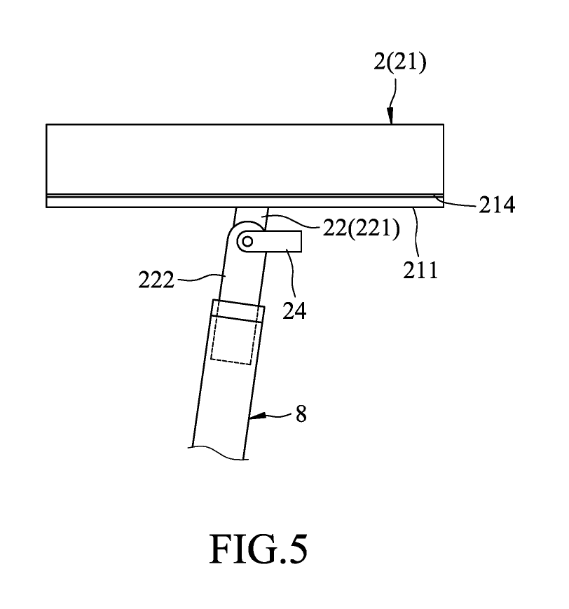

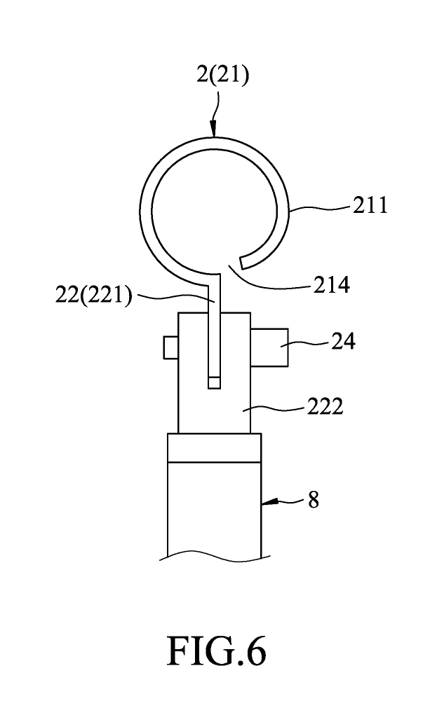

Referring to FIGS. 5 and 6, a third embodiment of the hard seat device 2 for a bicycle is essentially similar to the first embodiment, except that the linking unit 22 of the third embodiment further has a connecting member 222, and that the main body 211 of the hard seat member 21 further has a slit 214.

The slit 214 is formed in a bottom portion of the main body 211 for communicating the elongated hole 212 with the external environment, and extends through the main body 211 in the front-rear direction. In this embodiment, the hard seat member 21 is a hollow aluminum tube that has the same width at both the front and rear ends, and that has an elongated portion being carved out to form the slit 214.

The linking member 221 is a metal plate, and is first welded to the hard seat member 21, then pivotally connected to the connecting member 222 through a Buick-release structure 24. The connecting member 222 is substantially cylindrical, with its outer diameter thereof being substantially the same as an inner diameter of the seatpost 8 to be fitted into the seatpost 8. The angle of inclination of the hard seat member 21 can thereby be adjusted by pivoting the linking member 221.

By virtue of the slit 214 formed in the bottom portion of the main body 211, the hard seat member 21 is rendered resilient, so that shock experienced by the rider when riding can be reduced. Therefore, the third embodiment not only has the advantages of the first embodiment, but further has the advantage of shock reduction.

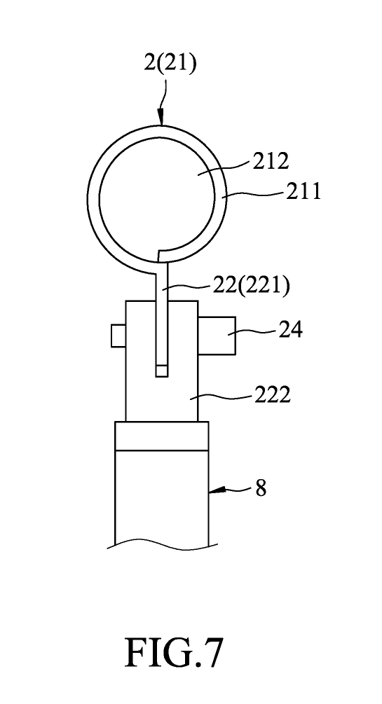

Referring to FIG. 7, a fourth embodiment of the hard seat device 2 for a bicycle is essentially similar to the third embodiment, except that the main body 211 of the hard seat member 21 of the fourth embodiment is rolled from a single piece of plate material with two longitudinal portions thereof being overlapped to form a double-layer structure. The elongated hole 212 is defined by the surrounding plate material, and extends in the front-rear direction. In this embodiment, the plate material is a metal plate.

Since the main body 211 is of a rollable material, a certain level of resiliency is ensured. Another method of forming the main body 211 of the fourth embodiment is to further roll the main body 211 of the third embodiment until two longitudinal portions of the main body 211 which cooperatively define the slit 214 overlap each other (i.e., the slit 214 is no more exist). In this way, the weight-supporting capacity of the left and right sides of the main body 211 can be more even. Therefore, the fourth embodiment not only has the advantages of the third embodiment, but bears weight more evenly so that riding comfort is enhanced.

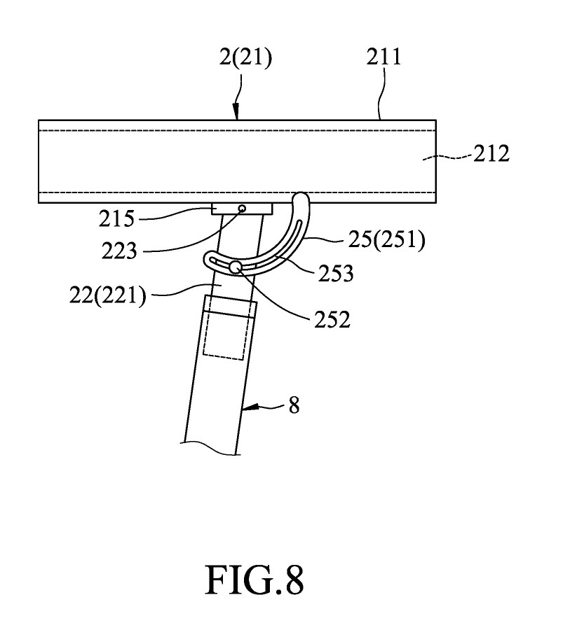

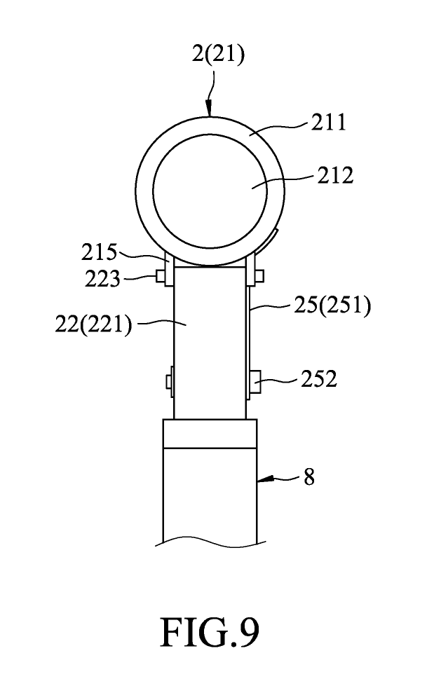

Referring to FIGS. 8 and 9, a fifth embodiment of the hard seat device 2 for a bicycle is essentially similar to the first embodiment, except that the fifth embodiment further includes an angle adjusting mechanism 25, and that the hard seat member 21 and the linking unit 22 have a different method of connection.

The main body 211 of the hard seat member 21 further has a pivot portion 215 formed at a bottom end of the main body 211. The linking unit 22 further has a pivot member 223 formed at a top end portion of the linking member 221 of the linking unit 22, and is mounted pivotally to the pivot portion 215 of the hard seat member 21.

The angle adjusting mechanism 25 has an adjusting member 251 provided on the hard seat member 21 and formed with a curved groove 253 that is curved with respect to a center of curvature located at the pivot member 223, and a locking member 252 extending through the curved groove 253 for releasably locking the adjusting member 251 to the linking member 221 of the linking unit 22. In this embodiment, the locking member 252 is a quick-release structure.

By pivoting the hard seat member 21 to an angle most suitable for a rider, then fixing the adjusting member 251 to the linking member 221 with the locking member 252, the hard seat member 21 can be stabilized in position.

Therefore, the fifth embodiment not only has the advantages of the first embodiment, but discloses a design with an angle adjusting mechanism as an alternative for the rider.

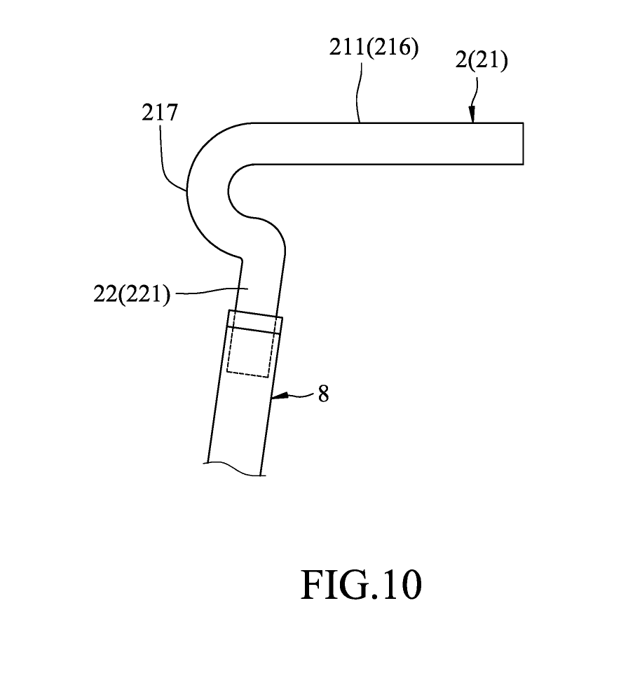

Referring to FIG. 10, a sixth embodiment of the hard seat device 2 for a bicycle is essentially similar to the first embodiment, except that the main body 211 of the hard seat member 21 of the sixth embodiment is made of metal, and bends in a manner that divides the main body 211 into a support portion 216 that is adapted for contacting the hard protective cycling pad 9 (see FIG. 3), and a curved portion 217.

The curved portion 217 is arc-shaped and is bent downwardly from a front end of the support portion 216 to connect with the linking member 221 of the linking unit 22. In this embodiment, the curved portion 217 is U-shaped and is connected at one end to the support portion. 216, and the other end to the linking member 221.

In this embodiment, the hard seat member 21 and the linking member 221 are formed as one piece, and is bent from a metal tube.

Since the main body 211 is made of metal, the U-shaped curved portion 217 has enough resiliency to absorb and reduce shock from cycling. Therefore, the sixth embodiment not only has the advantages of the first embodiment, but further has the advantage of shock reduction.

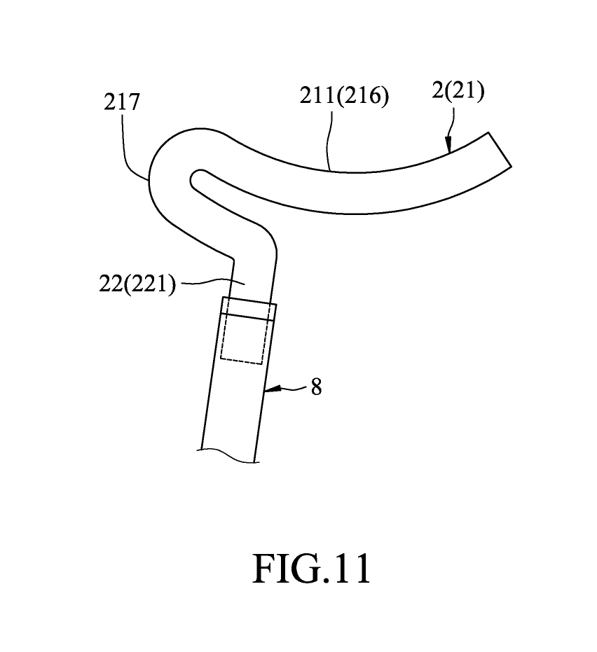

Referring to FIG. 11, a seventh embodiment of the hard seat device 2 for a bicycle is essentially similar to the sixth embodiment, except that the support portion 216 of the main body 211 of the seventh embodiment is slightly curved and has front and rear ends opposite to each other and being curved upwardly.

In this way, not only is it harder for the rider to slide off of the front and rear ends, but allows the rider to take advantage of the curvature to find a most suitable contact angle for sitting.

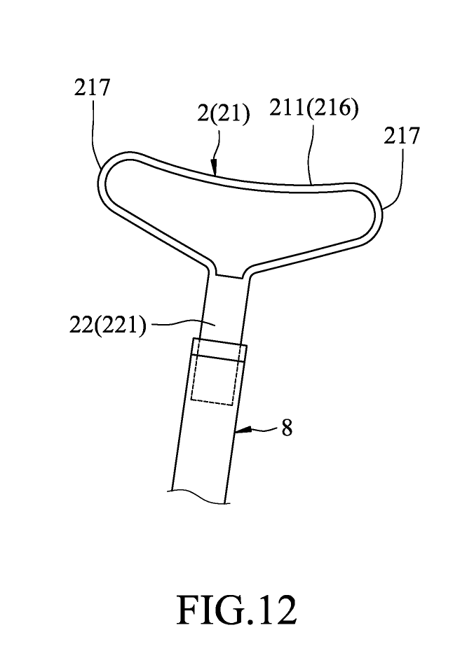

Referring to FIG. 12, an eight embodiment of the hard seat device 2 for a bicycle is essentially similar to the seventh embodiment, except that the main body 211 of the hard seat member 21 of the eighth embodiment is made of metal and has front and rear parts that are respectively bent downwardly to form a roughly triangular shape. The shape divides the main body 211 into a support portion 216 that is adapted for contacting the hard protective cycling pad 9, and that has opposite front and rear ends, and two curved portions 217. The two curved portions 217 are both arc-shaped and are bent downwardly and respectively from the front and rear ends of the support portion 216 to connect with the linking member 221 of the linking unit 22.

Since the front and rear parts of the main body 211 has the two curved portions 217 respectively fixed to the linking member 221, a good overall support is provided to the rider, and can at the same time absorb and reduce shock.

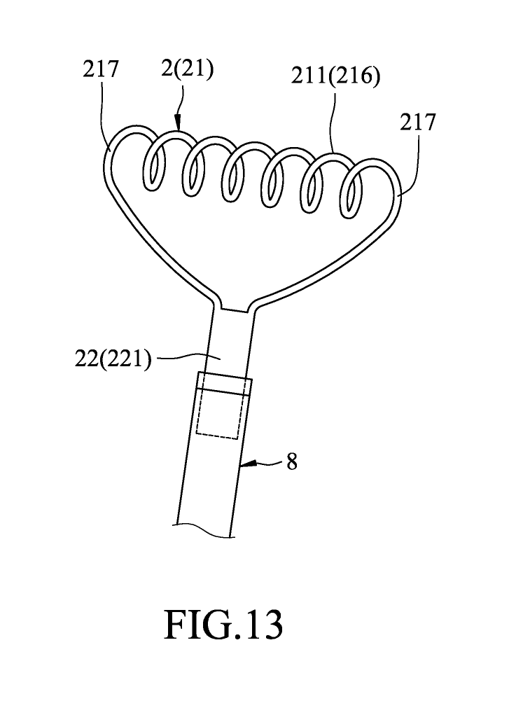

Referring to FIG. 13, a ninth embodiment of the hard seat device 2 for a bicycle is essentially similar to the eighth embodiment, except that support portion 216 of the main body 211 of the hard seat member 21 of the ninth embodiment extends helically in the front-rear direction.

The helical configuration of the support portion 216 allows the main body 211 to have an even better shock-reducing capability. Therefore, not only does the ninth embodiment have the advantages of the eighth embodiment, but also further enhances on the shock-reduction aspect thereof.

In sum, the hard seat device 2 according to the disclosure can accommodate the buttocks of a rider with different structural arrangements and can reduce overall weight and drag, thereby achieving the effect of the present disclosure.

In the description above, for the purposes of explanation, numerous specific details have been set forth in order to provide a thorough understanding of the embodiments. It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects.

While the disclosure has been described in connection with what is considered the exemplary embodiment, it is understood that this disclosure is not limited to the disclosed embodiment but is intended to cover various arrangements included within the spirit and scope of the broadest interpretation so as to encompass all such modifications and equivalent arrangements.

What is claimed is:

1. A hard seat device adapted to be mounted on a seatpost of a bicycle for supporting a hard protective cycling pad thereon, said hard seat device comprising:
a hard seat member including a main body that is adapted for contacting the hard protective cycling pad, and that is elongated without any part expanding laterally for supporting buttocks of a rider; and
a linking unit mounted to said hard seat member and adapted to be coupled to the seatpost.

2. The hard seat device as claimed in claim 1, wherein said main body of said hard seat member has an elongated hole extending therethrough in a front-rear direction.

3. The hard seat device as claimed in claim 2, wherein said main body of said hard seat member further has a slit extending therethrough in the front-rear direction, and formed in a bottom portion thereof for communicating said elongated hole with the external environment.

4. The hard seat device as claimed in claim 2, wherein said main body of said hard seat member is rolled from a single piece of plate material with two longitudinal portions thereof being overlapped to form a double-layer structure.

5. The hard seat device as claimed in claim 2, wherein said main body of said hard seat member has front and rear ends that are opposite with each other in the front-rear direction and that are curved upwardly.

6. The hard seat device as claimed in claim 1, wherein said linking unit includes a linking member that is mounted to said hard seat member, that is substantially cylindrical and that is adapted to be inserted into the seatpost.

7. The hard seat device as claimed in claim 6, wherein said linking unit further includes a pivot member formed at a top end portion of said linking member, said hard seat member being mounted pivotally to said pivot member.

8. The hard seat device as claimed in claim 7, further comprising an angle adjusting mechanism that includes:
an adjusting member provided on said hard seat member and formed with a curved groove that is curved with respect to a center of curvature located at said pivot member; and
a locking member extending through said curved groove for releasably locking said adjusting member to said linking member.

9. The hard seat device as claimed in claim 1, wherein said linking unit includes:
a linking member that is mounted to said hard seat member; and
a connecting member that is adapted to be connected to the seatpost and that is connected to said linking member.

10. The hard seat device as claimed in claim 9, wherein said connecting member is connected pivotally to said linking member through a quick-release structure.

11. The hard seat device as claimed in claim 1, wherein said main body of said hard seat member has:
a support portion adapted for contacting the hard protective cycling pad; and
a curved portion bent downwardly from a front end of said support portion and is connected to said linking unit.

12. The hard seat device as claimed in claim 11, wherein said support portion of said main body of said hard seat member has front and rear ends that are opposite with each other in the front-rear direction and that are curved upwardly.

13. The hard seat device as claimed in claim 1, wherein said main body of said hard seat member has:
a support portion that is adapted for contacting the hard protective cycling pad, and that has opposite front and rear ends; and
two curved portions that are bent downwardly and respectively from said front and rear ends of said support portion, and that are connected to said linking unit.

14. The hard seat device as claimed in claim 1, wherein said support portion of said main body of said hard seat member extends helically in the front-rear direction.

15. The hard seat device as claimed in claim 1, wherein said main body of said hard seat member has a plurality of apertures.

16. The hard seat device as claimed in claim 1, wherein:
said main body of said hard seat member has a pivot portion formed at a bottom end thereof; and
said linking unit includes a pivot member formed at a top end portion thereof and is mounted pivotally to said pivot portion of said main body of said hard seat member.
